(19) United States
(12) Patent Application Publication
(10) Pub. No.: US 2016/0118205 A1
(43) Pub. Date: Apr. 28, 2016

(54) KEYBOARD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: DONG-FENG LI, Wuhan (CN); CHING-JOU CHEN, New Taipei (TW); CHAO-CHI CHANG, New Taipei (TW); YUN-DONG XU, Wuhan (CN); CHANG-SHENG ZHOU, Wuhan (CN)

(21) Appl. No.: 14/530,090

(22) Filed: Oct. 31, 2014

(30) Foreign Application Priority Data
Oct. 22, 2014 (CN) 201410565418.7

(51) Int. Cl. H01H 13/81; H01H 13/10; H01H 13/84

(52) U.S. Cl. CPC H01H 13/81; H01H 13/84; H01H 13/10; H01H 2233/008; H01H 2217/00; H01H 2239/058

(57) ABSTRACT

Keyboard includes a keyboard unit for inputting commands into an electronic device and a base unit. The base unit includes a first part and a second part. The keyboard unit is movably received in the first part to connect the second part, thereby the keyboard unit and the second part are together configured to operate the electronic device.

### FIELD

The subject matter herein generally relates to a keyboard.

### BACKGROUND

In electronic devices such as personal computers, cellular phones, and PDAs (Personal Digital Assistant), etc., there is typically a keyboard (keyboard unit) having multiple operating keys. The keyboard is typically connected to a casing.

### BRIEF DESCRIPTION OF THE DRAWINGS

Implementations of the present technology will now be described, by way of example only, with reference to the attached figures.

FIG. 1 is an exploded, isometric view of an embodiment of a keyboard.

FIG. 2 is an exploded, isometric view of an embodiment of a keyboard unit of the keyboard of FIG. 1.

FIG. 3 is an assembled view of an embodiment of the keyboard of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a keyboard. The keyboard comprises a keyboard unit for inputting commands into an electronic device and a base unit. The base unit comprises a first part and a second part. The keyboard unit is movably received in the first part to connect the second part, thereby the keyboard unit and the second part are together configured to operate the electronic device.

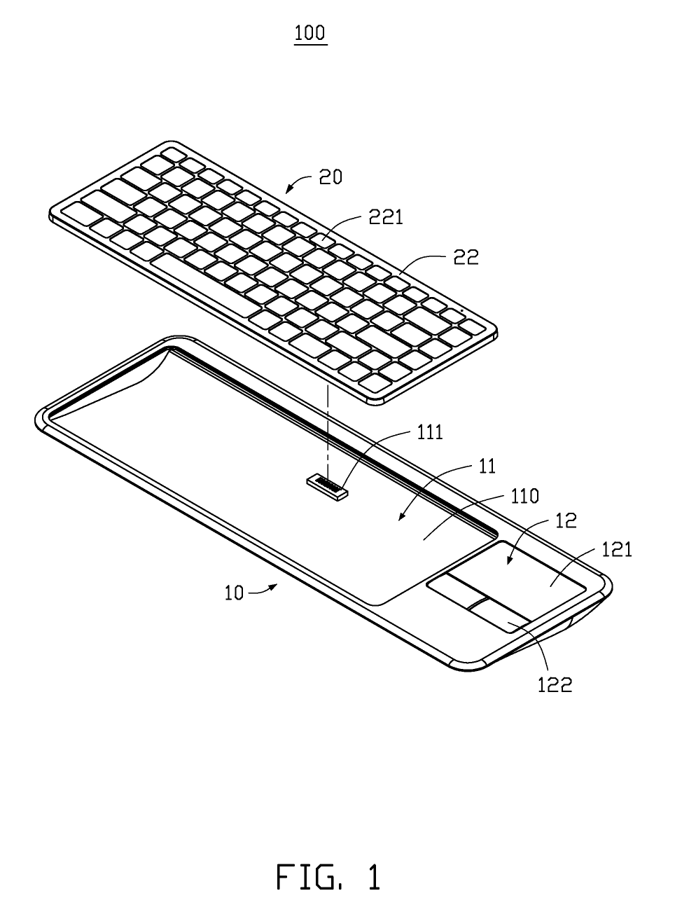

FIG. 1 illustrates an embodiment of a keyboard 100. The keyboard 100 comprises a base unit 10 and a keyboard unit 20 configured to be attached to the base unit 10.

The base unit 10 can be divided into a first part 11 and a second part 12 adjacent to the first part 11. The first part 11 can be a receiving area 110 with a first connector 111 being located therein. In at least one embodiment, the receiving area 110 can be a concave slot that is used to receive the keyboard unit 20. The second part 12 can be a touchpad which comprises two touching areas 121 and two pressing buttons 122 located between the two touching areas 121. The second part 12 is electronically coupled to the first connector 111.

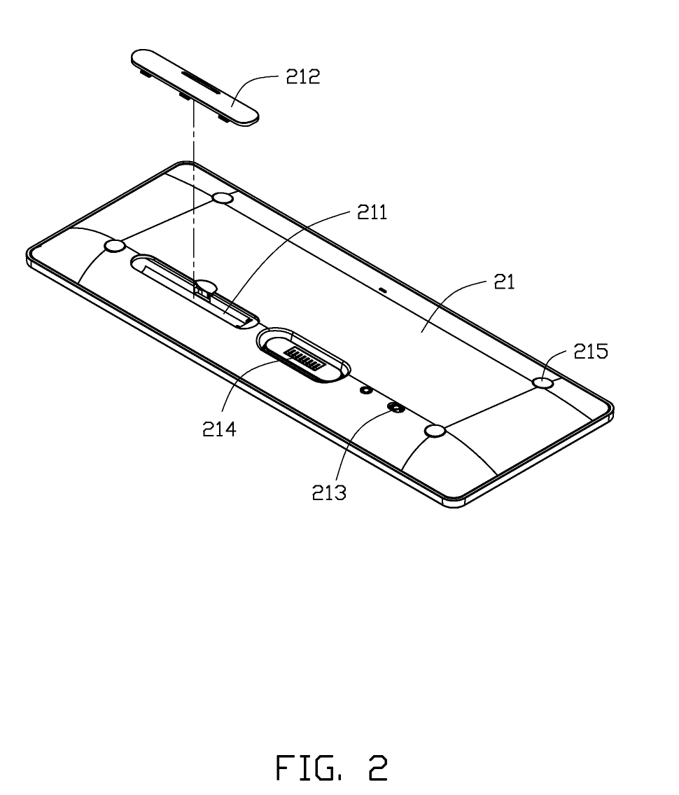

FIGS. 1-2 illustrate an embodiment of the keyboard unit 20. The keyboard unit 20 comprises a bottom portion 21 and a panel 22 located on the bottom portion 21 The keyboard unit 20 can be connected to an electronic device (not shown), such as personal computers, cellular phones, and PDAs (Personal Digital Assistant) by BLUETOOTH. A receiving slot 211 is defined in the bottom portion 21 and is used to receive a battery (not shown). A cover 212 can be secured to the bottom portion 21 to cover the receiving slot 211 for preventing the battery from exposing out of the receiving slot 211. In at least one embodiment, the cover 212 can be secured to edges of the receiving slot 211 by clips or screws. A switch 213 and an inserting slot 214 are located on the bottom portion 21. The switch 213 can be used to control the keyboard unit 20, and the inserting slot 214 is configured to receive the connector 111. A plurality of foot pads 215 is located on the back of the bottom portion 21 to support the keyboard 20. A plurality of buttons 221 is located on the front of the bottom portion 21 to input commands into the electronic device.

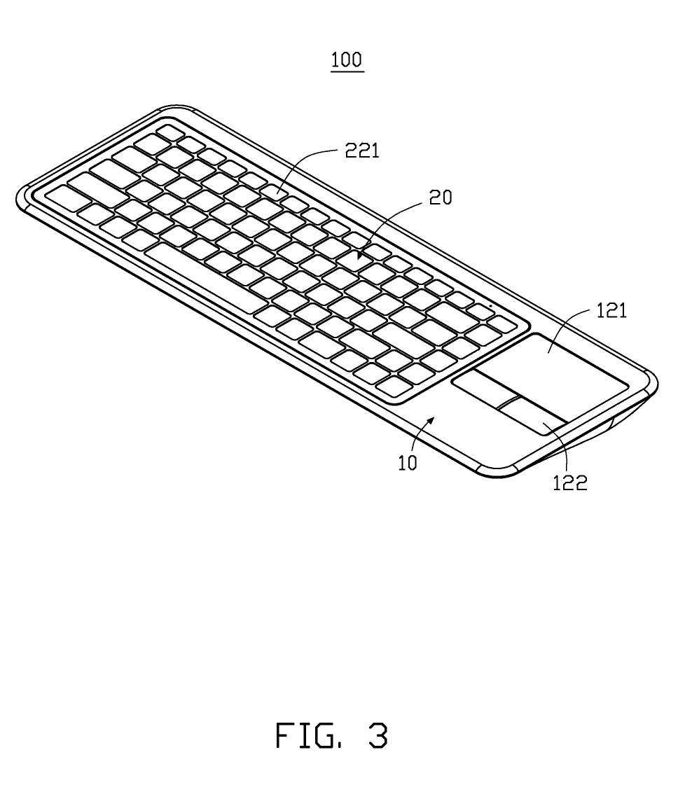

FIG. 3 illustrates an embodiment of the keyboard 100. In assembly, the battery is inserted into the receiving slot 211, and the cover 212 is covered on the receiving slot 211. When only commands need to input into the electronic device, the switch 213 is switched on to power on the Bluetooth, so that the keyboard unit 20 can be connected to the electronic device. Therefore, the keyboard unit 20 can be used to a common keyboard to input commands into the electronic device.

When the electronic device needs to be operated at the same as a mouse, the keyboard unit 20 is secured to the base unit 10 by means, such as clips and screws, and is received in the receiving area 110 for allowing the connector 111 to insert into the inserting slot 214. Therefore, the keyboard unit 20 can be connected to the second part 12, and the second part 12 can be connect the electronic device by the connector 111 to be used to the touchpad for operating the electronic device.

The embodiments shown and described above are only examples. Many details are often found in the art such as the other features of a keyboard unit. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A keyboard comprising:
a keyboard unit configured to input commands into an electronic device; and
a base unit comprising a first part and a second part;
wherein the keyboard unit is movably received in the first part to electronically connect to the second part, thereby the keyboard unit and the second part are together configured to operate the electronic device.

2. The keyboard of claim 1, wherein the second part is a touchpad.

3. The keyboard of claim 1, wherein a connector is located on the first part and is electronically coupled to the second part.

4. The keyboard of claim 2, wherein the keyboard unit comprises an inserting slot, and the connector is engaged in the inserting slot to connect the second part to the keyboard unit.

5. The keyboard of claim 1, wherein the first part is a receiving area, and the keyboard unit is received in the first part.

6. The keyboard of claim 1, wherein the keyboard unit comprises a switch, and the switch is configured to be switched on to power on a Bluetooth in the keyboard for allowing the keyboard unit to connect the electronic device.

7. The keyboard of claim 4, wherein a receiving slot is defined in the keyboard unit, and the receiving slot is configured to receive a battery.

8. The keyboard of claim 6, wherein a cover is movably attached to the keyboard unit, and the cover covers the receiving slot to prevent the battery from exposing out of the receiving slot.

9. The keyboard of claim 1, wherein a plurality of foot pads is located on the back of the bottom portion to support the keyboard.

10. A keyboard comprising:
a keyboard unit configured to input commands into an electronic device and comprising an inserting slot; and
a base unit comprising a first part and a second part; a connector is located on the first part and electronically connects the second part;
wherein the keyboard unit is movably in a direction that is substantially perpendicular to the first part to engage the connector in the inserting slot for allowing the keyboard unit electronically to connect the second part, thereby the keyboard unit and the second part are together configured to operate the electronic device.

11. The keyboard of claim 10, wherein the second part is a touchpad.

12. The keyboard of claim 10, wherein the first part is a receiving area, and the keyboard unit is received in the first part.

13. The keyboard of claim 10, wherein the keyboard unit comprises a switch, and the switch is configured to be switched on to power on a Bluetooth in the keyboard for allowing the keyboard unit to connect the electronic device.

14. The keyboard of claim 13, wherein a receiving slot is defined in the keyboard unit, and the receiving slot is configured to receive a battery.

15. The keyboard of claim 14, wherein a cover is movably attached to the keyboard unit, and the cover covers the receiving slot to prevent the battery from exposing out of the receiving slot.

16. The keyboard of claim 10, wherein a plurality of foot pads is located on the back of the bottom portion to support the keyboard.
